(19) United States
(12) Patent Application Publication
(10) Pub. No.: US 2005/0149568 A1
(43) Pub. Date: Jul. 7, 2005

(54) Content preserving data synthesis and analysis

(75) Inventors: Kenneth M. Bryden, Ames, IA (US); Daniel Abram Ashlock, Guelph (CA)

Correspondence Address: MCKEE, VOORHEES & SEASE, P.L.C., 801 GRAND AVENUE, SUITE 3200, DES MOINES, IA, 50309-2721, US

(73) Assignee: IOWA STATE UNIVERSITY RESEARCH FOUNDATION, INC., Ames, IA (US)

(21) Appl. No.: 10/998,261

(22) Filed: Nov. 26, 2004

Related U.S. Application Data
(60) Provisional application No. 60/525,608, filed on Nov. 26, 2003.

(51) Int. Cl. G06F 7/00

(52) U.S. Cl. 707/104.1

(57) ABSTRACT

The invention includes methods for content preserving data synthesis. In one method, data is collected into a data domain. The data domain is decomposed into self-organizing parts. Each self-organizing part is described by a descriptor or algorithm. The method can be performed dynamically The algorithm used to describe each self-organizing part can be a weighted Voroni tessellation.

### CROSS-REFERENCE TO RELATED APPLICATIONS

This application is a conversion of Provisional Application No. 60/525,608 filed Nov. 26, 2003, herein incorporated by reference in its entirety.

### BACKGROUND OF THE INVENTION

Although computing power is growing rapidly our ability to gather data is growing faster than our ability to store, interact with, and use this data. Recognizing this phenomenon, the term “data tomb” is entering our lexicon. This describes the data that will be collected, stored, and unused. The challenges of collecting and then using disparate massive data sets are significant. Current data mining techniques use for massive data set storage and management have several weaknesses. Generally these techniques are static and do not support continuing time dependent additions to the data except in formats/mappings that have already been found. Additionally, most of these mappings blur the discontinuities in the data and often it is the discontinuities that are the most important aspect of the data set. Once the mapping, neural net or other data simulation scheme is established the original data is either discarded or else stored. If deleted the original fidelity of the data set is lost. If stored, the stored data is still in a raw, uncatalogued state that makes it difficult to return to the data and find new insights when a new issue arises.

Therefore, it is a primary object, feature or advantage of the present invention to improve upon the state of the art.

It is a further object, feature or advantage of the present invention to provide a methodology for organizing, accessing, visualizing, sorting, storing, analyzing and/or optimizing large data sets.

A still further object, feature or advantage of the present invention is to provide a methodology for retrieving useful information from data collected in real-time.

Another object, feature or advantage of the present invention is to provide a methodology for working with large data sets that does not obscure the discontinuities within the data.

Yet another object, feature, or advantage of the present invention is to overcome the weaknesses in mapping, pattern recognition, and other data analysis methodologies.

These, and/or other objects, features, or advantages of the present invention will become apparent from the specification and/or claims that follow.

### SUMMARY OF THE INVENTION

The present invention provides for content preserving data synthesis. In particular, the invention provides for using a generalizable algorithm that can organize and access, visualize, sort, store, analyze and optimize large datasets. Engineering industries generate a large volume of data (typically of the order of terabytes) from design, manufacturing, service, etc. Invariably this data contains vital information that is not readily usable for further analysis and decision-making. The purpose of collecting and maintaining data is lost if it is not being utilized. The methodology of the present invention helps engineering industries reduce product design lead-time and improve product performance by getting maximum information from the collected data.

Key aspects of the methodology of the present invention include the ability to develop tools that enable the data to continue to grow and self organize in response to new content and user query. In this way the data can respond to the ongoing needs of the server. For example, in many cases old data is kept in case new questions arise—hence the rise of data tombs. However, finding the relationships and information in this unconnected, uncatalogued data for unanticipated questions is often like looking for a needle in a haystack. The present invention contemplates that the variables that supply the framework (geometry) and the variables/relationships which are the target can be selected by an analyst and the data will evolve the structure to respond to the request.

Although not limited to engineering data, the present invention is well-adapted for use with massive sets of engineering and can use existing physical laws or relationships in the data synthesis and analysis process.

According to one aspect of the present invention, a method for organizing data is disclosed. The method includes collecting data in a data domain. The data domain is decomposed into self-organizing parts. Each self-organizing part is described individually by a descriptor or algorithm. As the data domain grows, the data domain continues to be decomposed into self-organizing parts and each of the self-organizing parts is described again.

### BRIEF DESCRIPTION OF THE DRAWINGS

FIG. 1 is a flow diagram indicating one embodiment of the methodology of the present invention.

### DETAILED DESCRIPTION OF THE PREFERRED EMBODIMENT

The present invention provides for a content preserving data synthesis. The present invention contemplates implementation in a number of different manners for a number of different applications.

A data domain comprises a large data set or collection of data. Although the present invention contemplates that the size of this data set can vary, it is to be understood that the present invention is most advantageous when used with massive data sets, such as data sets that include on the order of one terabyte or more of data.

According to the present invention, the data domain is broken into or divided into self-organizing parts. The present invention builds on the adaptive modeling by evolving blocks algorithm (AMoEBA) to automatically decompose a growing data domain into self-organizing parts each described by different descriptions or algorithms. AMoEBA is described in P. Johnson, M. Bryden, D. Ashlock, and E. Vasquez, Evolving cooperative partial functions for data summary. Intelligent Engineering Systems through Artificial Neural Networks, p. 405-510, IEEE Press, 2001, herein incorporated by reference in its entirety. According to the present invention, the domain decomposition is evolved to store, access, and analyze these massive data sets.

The present invention contemplates that an analyst can direct the evolution of the self-organizing parts by providing variables to supply a framework for organization. In addition, an analyst can provide a selection of target variables or relationships that can be used to drive the decomposition of the data domain into self-organizing parts.

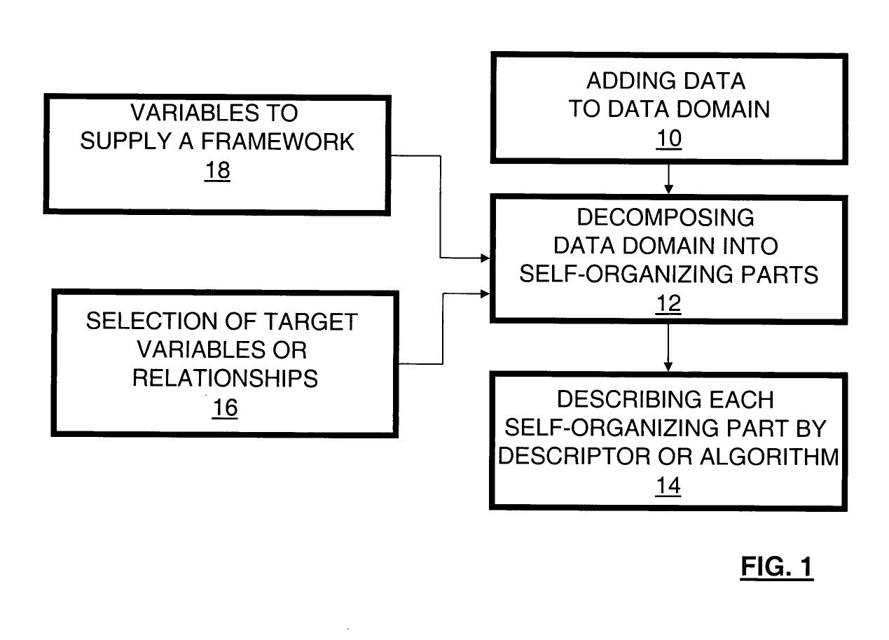

FIG. 1 illustrates one embodiment of the methodology of the present invention. In step 10, data is added to the data domain. In step 12, the data domain is decomposed into self-organizing parts. Then in step 14, a descriptor or algorithm is used to describe each self-organizing part. During this process, an analyst may provide variables to supply a framework for the decomposition and self-organization process by injecting such variables 18 into the step of 12 of decomposing the data domain of the self-organizing parts. Similarly, an analyst can provide a selection 16 of target variables/relationships in order to drive the step of 12 of decomposing the data domain.

It should be understood that the present invention is preferably implemented in software, but could also be implemented in hardware. It is also to be understood that it is preferred that the methodology of the present invention be performed dynamically and preferably in real-time. The present invention is particularly useful in applications involving engineering data, including applications that make use of decision support tools or real-time control.

One application of the present invention is to shorten the cycle time for decision support applications throughout the productive life of products such as machinery. Such products can generate useful data throughout their life cycle—e.g., product design data, analysis data, manufacturing data, price data, and service data. The present invention provides a methodology to bring these diverse data sets together while preserving a full fidelity of the data for further analysis. This adds value to the products. The data handling capabilities of the present invention therefore open the opportunity for methods to improve product performance, adopt broadly based virtual engineering and analysis tools, extend customer relationships, and develop information-based products. These benefits would not be achieved without the computational paradigm to achieve near or real-time information access and support of the present invention.

The present invention provides for taking pre-existing data and putting it into a form that is readily accessible by a decision support system. The present invention provides for an amicable method to process such a massive data set to discover useful interrelationships within the data in preferably near real-time. The present invention contemplates that the most interesting and important aspects of data often lie within discontinuous regions of the data.

For example, impending failure of a component may be signaled when the temperature suddenly rises due to a partial blockage. However, the temperature rise may not be sufficiently high to trigger an alarm and there may be other causes for the high temperature, e.g., higher loading, higher ambient temperatures, or other explanations. Currently, no formal data analysis and handling techniques exist to identify, correlate, and preserve this information. Correlating and finding such discontinuities within these massive and diverse data sets would be like finding a needle in a haystack without the methodology of the present invention.

The methodology of the present invention provides for handling these massive data sets by recognizing that data is not random or disconnected. Rather, data is interconnected through physical, engineering, and other relationships. These relationships can be quantified and exploited to access the data by creating self-organizing volumes. The methodology of the present invention organizes and accesses the data in this manner such that discontinuities will be made obvious. Additional data can be added to the data set on the fly, and the data can be accessed for design, analysis, and optimization. The present invention enables integration of data across the life cycle of products. This ability of the present invention to gather massive data sets, sort, store, and analyze the data on the fly, in an optimized/analyzing results has profound implications for a wide range of products.

One product of particular interest is machinery, such as an agricultural or construction vehicle. As digital controls become pervasive, such products will become mobile information platforms capable of communicating the current state of various components as well as the environment in which it operates. Thus, the methodology of the present invention can be used as a part of real-time decision support systems for these mobile information platforms of the future. Potential applications include, without limitation, real-time analysis of machine performance, real-time updates of digital components, onboard analytic support for diagnostics and repairs, real-time optimization of machine performance during operation in the field, control systems based on a large scale of data sets and physics based analysis, and rapid design cycles for product design and product improvement.

Another application in which the methodology of the present invention can be used is in oil exploration. This is an application where identifying discontinuities in data can be key. Often it is the discontinuity rather than a trend that is needed. For example, in oil exploration, the goal is to find cracks between seams in a rock layer. Whereas prior art data mining and compression techniques could not be used due to the loss of fidelity in the critical discontinuities, the present invention provides for identifying these discontinuities.

According to one embodiment of the present invention, a weighted Voronoi tessellation can be used for optimization purposes when data is divided into self-organizing parts. Applications of Voronoi tessellation are described in “Centroidal Voronoi Tessellations: Applications and Algorithms,” SIAM REVIEW, Vol. 41, No. 4, pp. 637-676, herein incorporated by reference in its entirety. Generally a tessellation may be defined as being a division of space into convex polygonal regions when in two-dimensions. Of course, the space may be of other metrics and the present invention contemplates that where tessellations are used, any metric for the data space may be used. Generally, tessellations may be used to characterize observed point process data or observed structures. A Voronoi tessellation is an example of a randomly generated tessellation that separates a space into regions using a point process. A weighted Voronoi tessellation may be also be called a Laguerre polyhedral decomposition and is an extension of Voronoi tessellations that considers that the points can have different weights.

The use of weighted Voronoi tessellations is described as used in one embodiment of the present invention, namely image segmentation. Image segmentation is one example of a decomposition process in that a data domain (an image) is decomposed into component parts (segments). One skilled in the art having the benefit of this disclosure will understand that weighted Voronoi tessellations apply to any number of applications of the present invention and is not limited to segmented images.

Moreover, other algorithms or descriptors can be used in place of weighted Voronoi tessellations. The weighted Voronoi tessellation is merely one manner in which self-organizing parts of a data domain can be described individually.

For explanation purposes for this example, an image is a rectangular array of pixels, probably given as red, green, and blue values in the range 0-255. Assume that the image is of size N×K pixels. A segmentation of the image is a division of the image into pixel subsets. Segmentation is usually performed to make image processing easier. The image subsets are called panes and the panes are created by a modification of a Voronoi tessellation.

A collection of M special pixels called centers is chosen. Denote these pixels by p₀, p₁, . . . , PM₋₁. Each pixel has coordinates (p₁^{x},p₁^{y}). The centers could be chosen at random. However, it is to be understood, that the centers can be chosen by an analyst as variables to supply the framework, thus allowing the analyst to direct the evolution of the self-organizing parts. Each center is assigned a weight ωᵢ in the range (0,1]. The initial segmentation assigns each pixel to the pane associated with a center as follows. For each pixel (x,y) of the image that pixel is assigned to the pane for whose center the quantity
ωᵢ×((x−pᵢ^{x})²+(y−pᵢ^{y})²)
is the smallest. Without the weights ωᵢ the panes created in this fashion would form a standard Voronoi tessellation, each plane being a simply polygon. With the weights the panes can have sides that are quadratic curves. The larger the weight of a pane the smaller a pane becomes. As the pane shrinks it also tends to approach a circular shape. We call the resulting segmentation a weighted Voronoi tessellation.

Assume that our goal is to adjust the weights so that panes contain roughly the same amount of information. The correct definition of “information” in this context depends on the exact type of compression we are using. A couple of examples:
1) If we are replacing the pixels of a pane P with the average color of the pane we want to equalize total chromatic variation across panes. For each of red, green, and blue, the sum over the pixels of the squared difference of the color value from the average color value is the total variation of that color. The total variation is then to balance for human vision or just the sum of the square roots of the numbers of data preservation. The funny numbers are the luminance coefficients that balance the importance of the colors for human eyes.
   0.299\sqrt{(red)}+0.587\sqrt{(green)}+0.114\sqrt{(blue)}
2) If we are differencing the stream of pixels and compressing the stream we want to minimize the absolute value of the difference in each of R, G, and B pixels in a pane in reading order. Notice this will be horizontal lines of pixels crossing the pane.

To balance the tessellation we iteratively increase the weights of panes with above average variation and decrease the weights of panes with below average variation. The increase/decrease increment should be small and chosen (by experimentation) to permit rapid convergence without ringing from overshoot. The size of the correction is generally expected to decrease with each cycle of weight adjustment.

There are many available compression methods and information measures. Each has its own right speed for balancing. In addition to balancing weights we can move, split or merge panes that are “far from average”. These types of operations can occur in the decomposition and self-organization process. Thus, in this manner, the weighted Voronoi tessellations are used to decompose the data domain (image) into the self-organized parts (panes). In the above example, the variables that supply the framework include the initial center points as well as the R, G, and B values for each pixel, and the location of each pixel or spatial relationship between the pixels and the centers. The target variables or relationship is the total chromatic variation across panes. In this example, the data domain can grow in a number of ways. For example, the size of the image could increase, the image could be one in a collection of images and additional images could be added over time, or data could be otherwise added.

One skilled in the art having the benefit of this disclosure will appreciate the far-reaching and broad implications of what is disclosed. In particular, the data domain is not limited to an image or a collection of images. Rather, the data domain includes any amount of data (preferably one Terabyte or more of data) and include data of all types. The present invention contemplates that the variables that supply the framework (geometry) and the variables/relationships which are the target are not limited to pixel position or color value, but can be any type of data. For example, where the data collection includes video, another variable/relationship would be a temporal variable/relationship. The self-organization of the data is not limited to a pane of an image, but can be another type of self-organized structure as would be appropriate in a particular application. Moreover, it is to be understood that the weighted Voroni tessellations are merely one way of describing the self-organizing parts. The present invention contemplates that other appropriate algorithms or descriptors can be used, including, but not limited to other forms of tessellations or optimization algorithms.

One skilled in the art having the benefit of this disclosure will appreciate that the weighted Voroni tessellations can be applied to the decomposition and self-organization process in other ways depending upon the specific application, the variables/relationships of the framework, and the variables/relationship that is the target. The use of the Voroni tessellation in the manner shown allows for content preserving data synthesis and analysis.

Therefore, a method for organizing data has been disclosed. The present invention contemplates numerous variations in the specific applications in which the invention is applied, the algorithms or descriptors used to describe the self-organized parts, and the variables/relationships of interest. These and other variations are well within the scope of the present invention.

1. A method for organizing data, comprising:
(a) collecting data in a data domain;
(b) decomposing the data domain into self-organizing parts;
(c) describing each self-organizing part individually by a descriptor or algorithm;
(d) repeating steps (b) and (c) as the data domain grows.

2. The method of claim 1 wherein steps (a)-(c) are performed dynamically.

3. The method of claim 1 wherein steps (a)-(c) are performed in real-time.

4. The method of claim 1 wherein the data is engineering data.

5. The method of claim 1 wherein the data domain is at least one terabyte in size.

6. The method of claim 1 wherein the self-organizing parts preserve discontinuities in the data.

7. The method of claim 1 wherein the step of describing each self-organizing part is performed by applying weighted Voronoi tessellations.

8. The method of claim 6 wherein the data is associated with oil exploration and wherein the discontinuities are associated with cracks between seams in rock layers.

9. The method of claim 1 wherein the data is associated with engineering functions selected from the set comprising engineering design, engineering operations, and engineering maintenance.

10. The method of claim 1 wherein the data is associated with functions selected from set comprising real-time analysis of machine performance, real-time updates of digital components, onboard analysis support for diagnostics and repairs, real-time optimization of machine performance during operation in the field, control systems based on large scale data sets and physics based analysis, and rapid design cycles for product design and product improvement.

11. The method of claim 1 further comprising receiving a selection of variables to supply a framework and a selection of target variables or target relationships from an analyst.

12. The method of claim 11 further comprising evolving a structure of the data domain at least partially based on the selection of variables to supply a framework.

13. The method of claim 11 further comprising evolving a structure of the data domain at least partially based on the selection of the target variables or target relationships.

14. The method of claim 1 wherein the data is engineering data and the self-organized parts are described by physical relationships.

15. A computer-assisted method for organizing data within a data domain, comprising:
supplying variables to provide a framework based on a request to be answered;
selecting at least one target wherein the at least one target is a variable or relationship, the selecting based on the request to be answered;
decomposing the data domain into self-organizing parts based on the variables that provide the framework and the at least one target;
describing each of the self-organizing parts.

16. The computer-assisted method of claim 15 wherein each of the self-organizing parts is defined by a tessellation.

17. The computer-assisted method of claim 15 wherein each of the self-organizing parts is described by a weighted Voroni tessellation.

18. The computer-assisted method of claim 15 further comprising accessing data within one of the self-organizing parts to determine an answer to the request.
